(19) United States
(12) Patent Application Publication
(10) Pub. No.: US 2018/0336147 A1
(43) Pub. Date: Nov. 22, 2018

(54) APPLICATION PROCESSOR INCLUDING COMMAND CONTROLLER AND INTEGRATED CIRCUIT INCLUDING THE SAME

(71) Applicant: SAMSUNG ELECTRONICS CO., LTD., Suwon-si (KR)

(72) Inventors: Kyung-Koo Lee, Hwaseong-si (KR); Ser-Hoon Lee, Yongin-si (KR)

(21) Appl. No.: 15/830,997

(22) Filed: Dec. 4, 2017

(30) Foreign Application Priority Data
May 18, 2017 (KR) 10-2017-0061642

(51) Int. Cl. G06F 13/16; G06F 5/06; G06F 15/78

(52) U.S. Cl. CPC G06F 13/1673; G06F 13/1615; G06F 2205/067; G06F 13/1694; G06F 15/7817; G06F 5/065

(57) ABSTRACT

An application processor (AP) includes intellectual property (IP) blocks and a system bus having a first command controller and a second command controller. Each of the first command controller and the second command controller includes a command distributor, a command buffer, and a command arbiter. Each command distributor receives first through third commands from a central processing unit (CPU). Each command buffer sequentially receives a first command and a second command from the command distributor and outputs the first command and the second command at different time slots. Each command arbiter receives the first and second commands from the command buffer and a third command from the command distributor and selectively outputs the same. First data corresponding the first command, second data corresponding to the second command, and a run-marker are stored in the command buffer.

### CROSS-REFERENCE TO RELATED APPLICATION

This application claims the benefit of Korean Patent Application No. 10-2017-0061642, filed on May 18, 2017, in the Korean Intellectual Property Office, the disclosure of which is incorporated herein in its entirety by reference.

### BACKGROUND

The disclosure relates to an application processor (AP) and an integrated circuit (IC), and more particularly, to an AP and an IC capable of reducing a time period for controlling operations of a plurality of intellectual property (IP) blocks.

With the development of integrated circuits (ICs), the miniaturization, high-reliability, high-speed, and low power-consumption of computers and various electronic devices are becoming more significant. A digital integrated circuit, such as a system-on-chip (SoC), is a technology for integrating complex systems having multiple functions into a single semiconductor chip.

Demands for application-specific integrated circuits (ASICs) and application-specific standard products (ASSPs) have been shifted to system-on-chips according to the tendency of convergence of computers, communications, and broadcasts. Furthermore, due to the miniaturization and weight reduction of information technology (IT) devices, system-on-chips and businesses related thereto have been promoted.

A system-on-chip may include a system bus for communications between intellectual property (IP) blocks. Thus, the structure of a bus included in an integrated circuit has become an important parameter due to the improved performance of an IP block.

### SUMMARY

The disclosure provides an application processor (AP) and an integrated circuit (IC) capable of reducing a time period for a central processing unit (CPU) to control a plurality of operations of an intellectual property (IP) block.

According to an aspect of the disclosure, there is provided an application processor (AP) that includes intellectual property (IP) blocks and a system bus having a first command controller and a second command controller. Each of the first command controller and the second command controller includes a command distributor, a command buffer, and a command arbiter. Each command distributor receives first through third commands from a central processing unit (CPU). Each command buffer sequentially receives a first command and a second command from the command distributor and outputs the first command and the second command at different time slots. Each command arbiter receives the first and second commands from the command buffer and a third command from the command distributor and selectively outputs the same. First data corresponding the first command, second data corresponding to the second command, and a run-marker are stored in the command buffer.

According to another aspect of the disclosure, there is provided an application processor (AP), including a plurality of intellectual property (IP) blocks, and a system bus including a plurality of command controllers that each includes a first-in first-out (FIFO) circuit. Each of the plurality of command controllers is configured to sequentially receive a first command and a second command from a central processing unit (CPU) and to sequentially output the first command and the second command First data corresponding the first command, second data corresponding to the second command, and a run-marker are stored in the FIFO circuit.

According to another aspect of the disclosure, there is provided an integrated circuit (IC), including a plurality of intellectual property (IP) blocks, and a system bus configured to output commands to the plurality of IP blocks. The system bus includes a command controller. The command controller includes: (1) a command distributor configured to receive a plurality of commands from a central processing unit (CPU), (2) a first-in first-out (FIFO) circuit configured to sequentially receive some of the plurality of commands from the command distributor, to store data corresponding to the some of the plurality of commands and to sequentially output the some of the plurality of commands, and (3) a command arbiter configured to receive and selectively output the some of the plurality of commands received from the FIFO circuit and another some of the plurality of commands directly received from the command distributor.

### BRIEF DESCRIPTION OF THE DRAWINGS

Embodiments of the disclosure will be more clearly understood from the following detailed description taken in conjunction with the accompanying drawings in which:

FIG. 1 is a block diagram showing an integrated circuit according to an example embodiment of the disclosure;

FIG. 2 is a block diagram showing a first command controller of an integrated circuit, according to an example embodiment of the disclosure;

FIGS. 3 through 5 are flowcharts of operations of an integrated circuit according to an example embodiment of the disclosure;

FIG. 6 is a block diagram showing a command buffer included in an integrated circuit according to an example embodiment of the disclosure;

FIG. 7 is a block diagram showing a first-in first-out (FIFO) circuit included in the command buffer of FIG. 6 and is a diagram for describing the operations of the FIFO circuit;

FIG. 8 is a diagram for describing a controller register included in the command buffer of FIG. 6;

FIG. 9 is a block diagram showing an integrated circuit according to an example embodiment of the disclosure;

FIG. 10 is a block diagram showing an integrated circuit according to an example embodiment of the disclosure;

FIG. 11 is a block diagram showing an integrated circuit according to an example embodiment of the disclosure; and

FIG. 12 is a diagram showing an example of an electronic system including an integrated circuit according to an example embodiment of the disclosure.

### DETAILED DESCRIPTION OF THE EMBODIMENTS

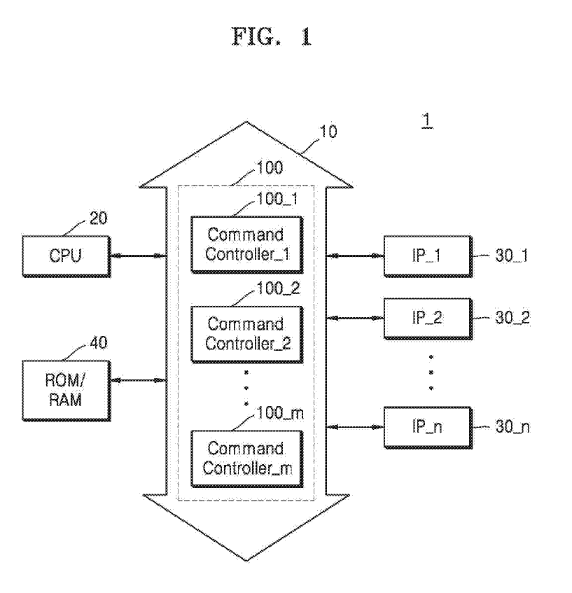

FIG. 1 is a block diagram showing an integrated circuit according to an example embodiment of the disclosure.

An integrated circuit 1 may be a controller or a processor that controls operations of an electronic system. According to embodiments, the integrated circuit 1 may be a system on chip (SoC), an application processor (AP), a mobile AP, or a control chip.

The integrated circuit 1 may be mounted in an electronic device, such as a laptop computer, a smart phone, a tablet PC, a personal digital assistant (PDA), an enterprise digital assistant (EDA), a digital camera, a portable multimedia player (PMP), a portable navigation device (PND), a handheld game console, a mobile internet device (MID), a multimedia device, a wearable computer, an Internet of things (IoT) device, an Internet of everything (IoE) device, or an e-book.

Referring to FIG. 1, the integrated circuit 1 may include a system bus 10, a central processing unit (CPU) 20, a plurality of intellectual property (IP) blocks 30_1, 30_2, and 30_n, and a ROM and/or a RAM 40.

The system bus 10 may interconnect the CPU 20 with the plurality of IP blocks 30_1, 30_2, and 30_n. Each of the CPU 20 and the plurality of IP blocks 30_1, 30_2, and 30_n may be a master block or a slave block. Each of the master blocks and slave blocks may perform a specific function in the integrated circuit 1. The master block and the slave block may be distinguished from each other based on whether a corresponding block has an authority to use the system bus 10. The master block may access the slave block via the system bus 10. On the other hand, the slave block may be controlled by the master block via the system bus 10. For example, the CPU 20 may be a master block, whereas all of the plurality of IP blocks 30_1, 30_2, and 30_n may be slave blocks. However, the disclosure is not limited thereto.

The system bus 10 may be implemented as a bus configured to operate according to a protocol of a certain standard bus specification. For example, the protocol may be the advanced microcontroller bus architecture (AMBA) protocol of an Advanced RISC Machine (ARM). Bus types of the AMBA protocol may include advanced high-performance bus (AHB), advanced peripheral bus (APB), advanced extensible interface (AXI), AXI4, AXI coherency extensions (ACE), etc. From among the bus types described above, the AXI is an interface protocol between IP blocks, providing multiple outstanding addressing functions and data interleaving functions. Furthermore, other types of protocols may be applied to the system bus 10, such as uNetwork of SONICs Inc., CoreConnect of IBM, and Open Core Protocol of OCP-IP.

The system bus 10 may include a plurality of command controllers 100 including first through m^{th} command controllers 100_1 through 100_m. Here, m may be a natural number equal to or greater than 3. The plurality of command controllers 100 may receive a plurality of commands from the CPU 20 and may store respective data corresponding to the plurality of commands, respectively. At this time, the plurality of commands may include information for setting a value of a special IP register (SFR) included in the plurality of IP blocks.

The plurality of command controllers 100 may sequentially output a plurality of commands received from the CPU 20 to at least one of the plurality of IP blocks 30_1, 30_2, and 30_n based on stored data. The plurality of command controllers 100 may temporarily store some of a plurality of commands received from the CPU 20 and perform an operation for outputting the stored commands to at least one of the plurality of IP blocks 30_1, 30_2, and 30_n in the order received. In other words, an operation similar to a command queue may be performed. Therefore, since the integrated circuit 1 according to the disclosure includes the plurality of command controllers 100, the CPU 20 may output a plurality of commands for operating the plurality of IP blocks 30_1, 30_2, 30_n in advance without being affected by time.

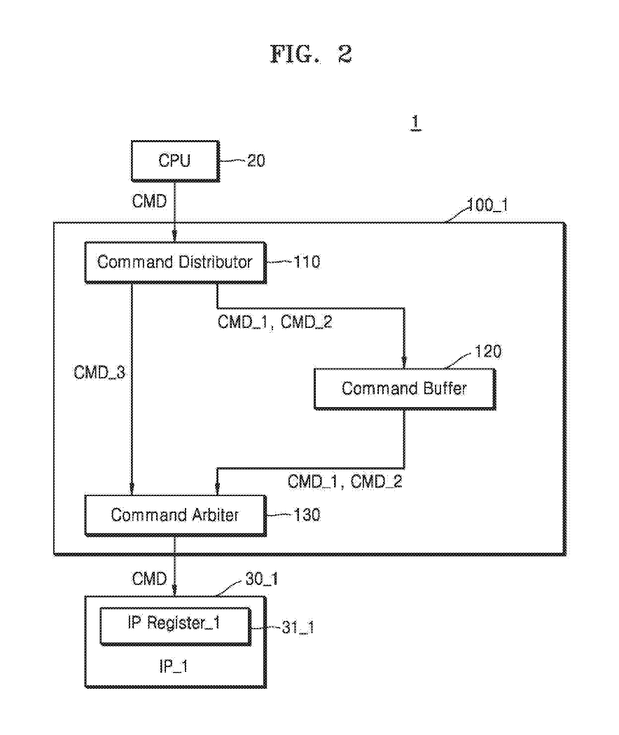

Although FIG. 1 shows that the system bus 10 includes the plurality of command controllers 100, the disclosure is not limited thereto, and the plurality of command controllers 100 may function as a single IP block connected to the system bus 10. The configuration of the plurality of command controllers 100 including a first command controller 100_1 will be described below in detail with reference to FIG. 2.

The CPU 20 may process or execute a program and/or data stored in the ROM and/or the RAM 40. According to an example embodiment, the CPU 20 may execute programs stored in the ROM and/or the RAM 40. The ROM may store programs and/or data and may be implemented as an erasable programmable read-only memory (EPROM) or an electrically erasable programmable read-only memory (EEPROM). Furthermore, the RAM may be implemented as a memory, such as a dynamic RAM (DRAM) or a static RAM (SRAM).

The plurality of IP blocks 30_1, 30_2, and 30_n may include first through n^{th} functional blocks 30_1 through 30_n. Here, n may be a natural number equal to or greater than 3. Each of the plurality of IP blocks 30_1, 30_2, and 30_n may receive a command via the system bus 10 and perform a certain operation in a system. Therefore, the system bus 10 may also be regarded as an IP block. The plurality of IP blocks 30_1, 30_2, and 30_n may include a plurality of special function registers and may perform certain operations based on values of the plurality of special function registers.

At least some of the plurality of IP blocks 30_1, 30_2, and 30_n may receive a plurality of commands from the plurality of command controllers 100 included in the system bus 10, respectively. The some of the plurality of IP blocks 30_1, 30_2, and 30_n may receive a plurality of commands from the CPU 20 not through the plurality of command controllers 100.

The plurality of IP blocks 30_1, 30_2, and 30_n may correspond to certain modules, such as a video module, a sound module, a display module, a memory module, a communication module, and a camera module. According to an example embodiment, the plurality of IP blocks 30_1, 30_2, and 30_n may be implemented as software. In this case, the CPU 20 may operate the plurality of IP blocks 30_1, 30_2, and 30_n by executing software stored in the ROM and/or the RAM 40. However, the disclosure is not limited the plurality of IP blocks 30_1, 30_2, and 30_n implemented as software.

FIG. 2 is a block diagram showing an integrated circuit according to an example embodiment of the disclosure and is a block diagram specifically showing the first command controller 100_1. Although FIG. 2 shows that the one first command controller 100_1 is connected to a first IP block 30_1 and transmits a plurality of commands CMD to the first IP block 30_1, an example embodiment of the disclosure is not limited to the connection between the one first command controller 100_1 and one IP block.

Referring to FIG. 2, the integrated circuit 1 may include the CPU 20, the first command controller 100_1, and the first IP block 30_1. The first command controller 100_1 may include a command distributor 110, a command buffer 120, and a command arbiter 130. Although FIG. 2 shows only the first command controller 100_1, the description of the first command controller 100_1 of FIG. 2 may be applied to each of the plurality of command controllers 100 of FIG. 1.

The CPU 20 may output a plurality of commands CMD to the first command controller 100_1. At this time, the plurality of commands CMD may be transmitted to the first IP block 30_1 and set the plurality of special function registers included in the first IP block 30_1 to specific values.

The first command controller 100_1 may receive a plurality of commands CMD including first through third commands CMD_1 through CMD_3 from the CPU 20. At this time, when the CPU 20 causes the first IP block 30_1 to perform a continuous operation, the CPU 20 may sequentially output a first command CMD_1 and a second command CMD_2 to the first command controller 100_1. When it is necessary for the CPU 20 to perform an urgent processing for the first IP block 30_1, the CPU 20 may output a third command CMD_3 to the first command controller 100_1.

The command distributor 110 may distribute a plurality of commands CMD into first and second commands CMD_1 and CMD_2 to be transmitted to the command buffer 120 and a third command CMD_3 to be transmitted to the command arbiter 130. According to an example embodiment, the command distributor 110 may be a decoder and may transmit the first command CMD_1 and the second command CMD_2 to the command buffer 120 and transmit the third command CMD_3 to the command arbiter 130, based on addresses received together with the plurality of commands CMD.

According to another example embodiment, the command distributor 110 may be configured to allow the CPU 20 to control the mode of the command distributor 110. For example, when the CPU 20 sets the command distributor 110 to a first mode and outputs the first command CMD_1 and the second command CMD_2, the command distributor 110 may transmit the first command CMD_1 and the second command CMD_2 to the command buffer 120. When the CPU 20 sets the command distributor 110 to a second mode and outputs the third command CMD_3, the command distributor 110 may transmit the third command CMD_3 to the command arbiter 130.

The command buffer 120 may include a first-in first-out (FIFO) structure. The command buffer 120 may sequentially receive the first command CMD_1 and the second command CMD_2 and output the first command CMD_1 and the second command CMD_2 to the command arbiter 130 in the order received.

The command arbiter 130 may transmit the first through third commands CMD_1 to CMD_3 to the first IP block 30_1. The first through third commands CMD_1 through CMD_3 may be independently transmitted to the first IP block 30_1 when the first through third commands CMD_1 through CMD_3 are respectively received by the command arbiter 130 in different time slots. On the other hand, when time sections in which the third command CMD_3 and the first and second commands CMD_1 and CMD_2 are respectively received by the command arbiter 130 overlap each other, the command arbiter 130 may preferentially output a command having a higher priority than other commands to the first IP block 30_1 based on priorities of the first through third commands CMD_1 through CMD_3. Therefore, according to an example embodiment, the command arbiter 130 may include a register in which priorities regarding received commands are stored.

For example, when time sections in which the third command CMD_3 and the first command CMD_1 or the second command CMD_2 are received by the command arbiter 130 overlap each other, the command arbiter 130 may be configured to output the third command CMD_3 to the first IP block IP_1. In other words, the third command CMD_3 received from the command distributor 110 may be configured to have a higher priority than the first command CMD_1 and the second command CMD_2 transmitted from the command buffer 120.

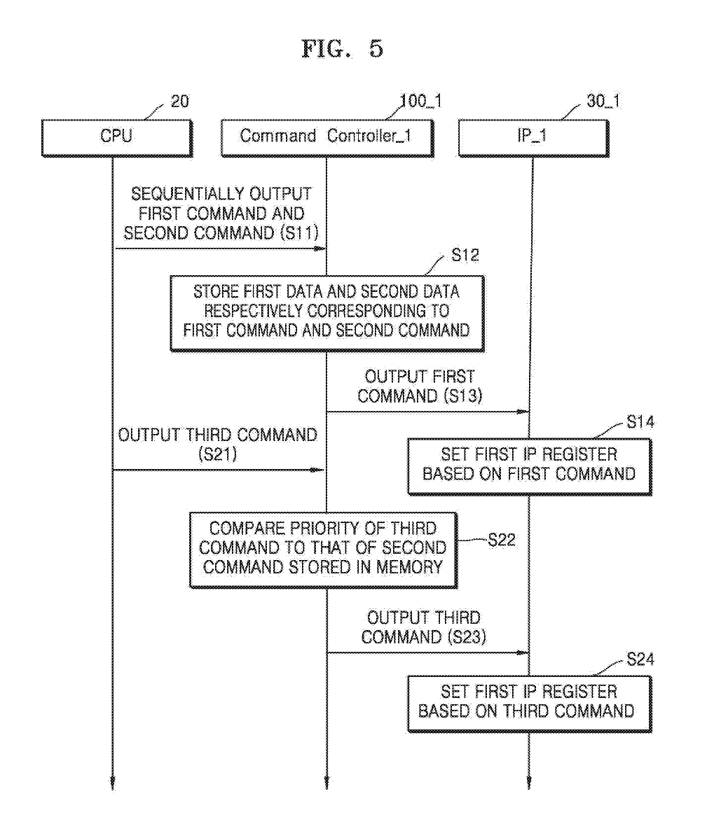

Therefore, even while a plurality of commands is being sequentially output from the first command controller 100_1, when an urgent processing for the first IP block 30_1 is necessary, the CPU 20 may transmit a new command to the first command controller 100_1, and the first command controller 100_1 may output data regarding the new command directly to the first IP block 30_1 without separately storing the data for the new command Detailed descriptions thereof will be given below with reference to FIG. 5.

The first IP block IP_1 may include a first IP register 31_1. The first IP register 31_1 may include a plurality of special function registers. When the first IP block IP_1 receives a command from the first command controller 100_1, at least some of the plurality of special function registers included in the first IP register 31_1 are set to specific values based on the received command, and the first IP block IP_1 may perform certain operations based on the values of the first IP register 31_1.

When a plurality of commands CMD are sequentially input to the first IP register 31_1, the first IP register 31_1 may be set a number of times corresponding to the number of commands CMD, and the first IP register IP_1 may perform successive operations based on the values of the first IP register 31_1. For example, the first command CMD_1 and the second command CMD_2 may set the first IP register 31_1 to a first value and a second value, respectively, such that the first IP block 30_1 performs a first operation and a second operation, which are different from each other.

When the third command CMD_3 is input to the first IP register 31_1, the first IP register 31_1 may be set again differently from the case where the first command CMD_1 and the second command CMD_2 are input and, based on the value of the IP register 31_1, the first IP block IP_1 may perform a new operation.

The first command controller 100_1 of the integrated circuit 1 according to the disclosure may receive a plurality of commands (e.g., the first command CMD_1 and the second command CMD_2) output from the CPU 20 and sequentially output the plurality of commands, thereby controlling the operation of the first IP block 30_1. While the first IP block 30_1 is operating, a plurality of commands is output from the first command controller 100_1 and the first IP block 30_1 is controlled to perform successive operations without an intervention of the CPU 20, and thus the burden on the CPU 20 may be reduced.

Furthermore, every time an operation of the first IP block 30_1 is completed, a next command is received from the first command controller 100_1 even when the first IP block 30_1 does not periodically transmit an interrupt signal to the CPU 20. Therefore, a time period for the first IP block 30_1 to prepare for a specific operation may be reduced.

Although FIG. 2 shows only the operation of the first IP block 30_1 connected to the first command controller 100_1, the plurality of IP blocks 30_1, 30_2, and 30_n may be respectively connected to command controllers, and the description of the operation of the block 30_1 may be equally applied thereto.

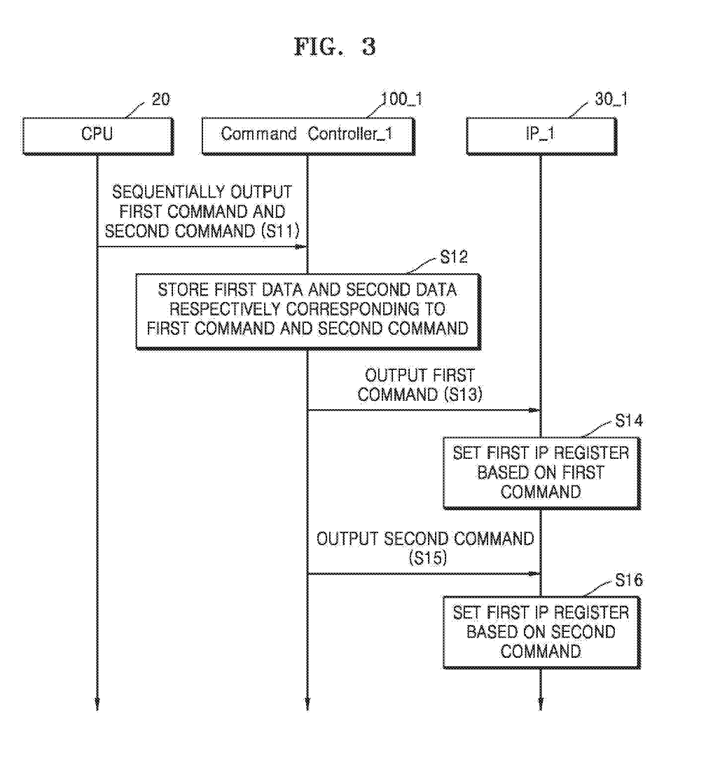

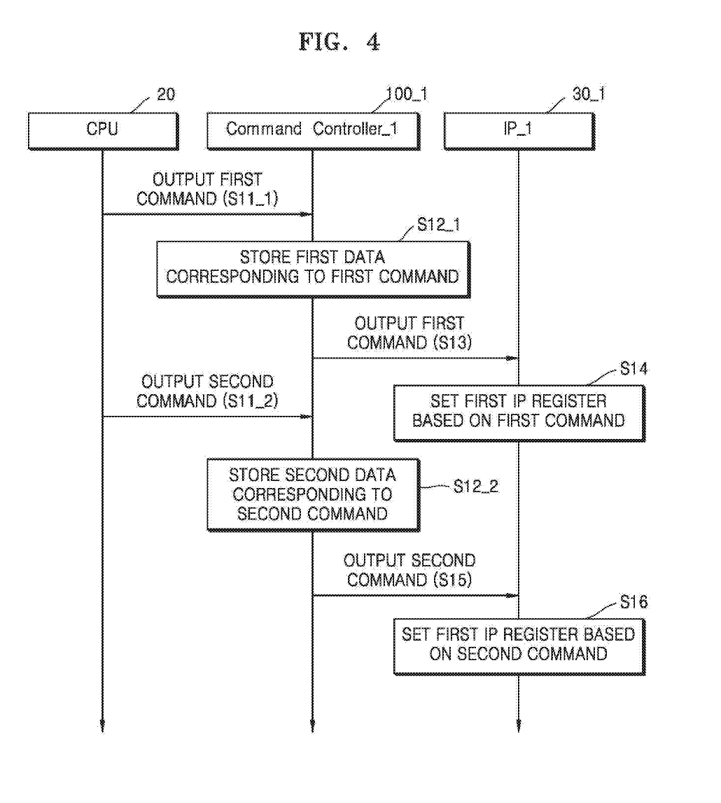

FIGS. 3 and 4 are flowcharts of operations of an integrated circuit according to an example embodiment of the disclosure and describe a case where a first command and a second command are received by the first command controller 100_1 and a third command is not received in FIG. 2.

Referring to FIGS. 2 and 3, the CPU 20 may sequentially output the first command CMD_1 and the second command CMD_2 for controlling the operation of the first IP block 30_1 (operation S11). Here, a first operation and a second operation of the first IP block 30_1 respectively according to the first command CMD_1 and the second command CMD_2 may be related to each other, and the first operation may be an operation to precede the second operation. For example, when the first IP block 30_1 is a camera module, the first operation and the second operation may be operations for successive photographing.

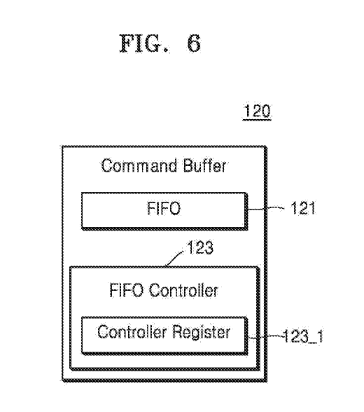

The first command controller 100_1 may receive the first command CMD_1 and the second command CMD_2 output from the CPU 20 and store first data and second data respectively corresponding to the first command CMD_1 and the second command CMD_2 in the command buffer 120 (operation S12). According to an example embodiment, the command buffer 120 may be a FIFO buffer, and the first data and the second data may be sequentially stored in the FIFO buffer. A detailed description of the FIFO buffer will be given below with reference to FIG. 6.

The first command controller 100_1 may output the first command CMD_1 to the first IP block 30_1 based on the first data (operation S13). The first IP block 30_1 may receive the first command CMD_1 and set the first IP register 31_1 based on the first command CMD_1 (operation S14). The first IP block 30_1 may perform a first operation according to the set value of the first IP register 31_1. The first IP register 31_1 may include a plurality of special function registers, and at least one some special function register from among the plurality of special function registers may be set to specific values by a first command CMD_1.

When the first operation of the first IP block 30_1 is completed, the first IP block 30_1 may transmit an interrupt signal to the first command controller 100_1. The first command controller 100_1 may output the second command CMD_2 to the first IP block 30_1 based on the stored second data (operation S15). The first IP block 30_1 may receive the second command CMD_2 and set the first IP register 31_1 again based on the second command CMD_2 (operation S16). The first IP block 30_1 may perform a second operation according to the set value of the first IP register 31_1. At least some special function registers from among the plurality of special function registers of the first IP register 31_1 may be set by the second command CMD_2.

Referring to FIGS. 2 and 4, the CPU 20 may preferentially output the first command CMD_1 for controlling the operation of the first IP block 30_1 (operation S11_1). The first command controller 100_1 may receive the first command CMD_1 output from the CPU 20 and store first data corresponding to the first command CMD_1 in the command buffer 120 (operation S12_1). The first command controller 100_1 may output the first command CMD_1 to the first IP block 30_1 based on the first data (operation S13). The first IP block 30_1 may receive the first command CMD_1 and set the first IP register 31_1 based on the first command CMD_1 (operation S14). The first IP block 30_1 may perform a first operation according to the set value of the first IP register 31_1.

After the first command controller 100_1 outputs the first command CMD_1 to the first IP block 30_1 in operation S13, the CPU 20 may output the second command CMD_2 for controlling the operation of the first IP block 30_1 (operation S11_2). The operation in which the CPU 20 outputs the second command CMD_2 may overlap operation S14 in which the first IP block 30_1 sets the first IP register 31_1. However, the disclosure is not limited thereto. Operation S13 in which first command controller 100_1 outputs the first command CMD_1 to the first IP block 30_1 may overlap operation S11_2 in which the CPU 20 outputs the second command CMD_2.

The first command controller 100_1 may receive the second command CMD_2 output from the CPU 20 and store second data corresponding to the second command CMD_2 in the command buffer 120 (operation S12_2). Therefore, operation S12_2 for storing the second data may be performed after operation S13 in which the first command controller 100_1 outputs the first command CMD_1.

The first command controller 100_1 may output the second command CMD_2 to the first IP block 30_1 (operation S15). The first IP block 30_1 may receive the second command CMD_2 and set the first IP register 31_1 based on the second command CMD_2 (operation S16). The first IP block 30_1 may perform a second operation according to the set value of the first IP register 31_1.

Therefore, in the integrated circuit 1 according to an example embodiment of the disclosure, the CPU 20 may: (1) transmit a new command (e.g., the second command CMD_2) to the first command controller 100_1 while a command (e.g., the first command CMD_1) is being output by the first command controller 100_1 to an IP block and IP registers of the IP block are being set and (2) store new data corresponding to the new data in the first command controller 100_1, thereby preparing a next operation of the IP block.

FIG. 5 is a flowchart showing operations of an integrated circuit according to an example embodiment of the disclosure and is a flowchart for describing a case where first to third commands are received by a first command controller in FIG. 2. In FIG. 5, operation S11 in which the CPU 20 sequentially outputs the first command CMD_1 and the second command CMD_2, operation S12 in which the first command CMD_1 and the second command CMD_2 are stored, operation S13 in which the first command controller 100_1 outputs the first command CMD_1, and operation S14 in which the first IP register 31_1 is set may be identical to those of FIG. 3. Therefore, detailed description thereof will be omitted.

Referring to FIGS. 2 and 5, the CPU 20 may output the third command CMD_3 (operation S21) after operation S12 in which the first command controller 100_1 stores first data and second data respectively corresponding to the first command CMD_1 and the second command CMD_2, Although FIG. 5 shows that operation S21 in which the CPU 20 outputs the third command CMD_3 overlaps operation S14 in which the first IP register 31_1 is set based on the first command CMD_1, embodiments of the disclosure are not limited thereto. According to an example embodiment, operation S21 in which the CPU 20 outputs the third command CMD_3 may overlap operation S13 in which the first command controller 100_1 outputs the first command CMD_1 or operation S12 in which the first command controller 100_1 stores the first data and the second data. In other words, when it is necessary for the first IP block 30_1 to perform a third operation to be performed before the first operation and the second operation respectively according to the first command CMD_1 and the second command CMD_2, the CPU 20 may output the third command CMD_3.

When the third command CMD_3 is received, the first command controller 100_1 may compare priorities of the second command CMD_2 and the third command CMD_3 (operation S22). Priorities of the plurality of commands CMD received by the first command controller 100_1 may be stored in the first command controller 100_1. Based on the stored priorities, the first command controller 100_1 may output the third command CMD_3 to the first IP block 30_1 (operation S23).

The first IP block 30_1 may receive the third command CMD_3 and set the first IP register 31_1 based on the third command CMD_3 (operation S24). The first IP block 30_1 may perform a third operation according to the value of the first IP register 31_1.

The first command controller 100_1 may output the third command CMD_3 to the first IP block 30_1 in operation S23 and then output the second command CMD_2 to the first IP block 30_1. The second IP terminal 30_1 may set the first IP register 31_1 based on the second command CMD_2 and perform the second operation according to the value of the first IP register 31_1.

Therefore, the integrated circuit 1 according to an example embodiment of the disclosure may store a plurality of pieces of data corresponding to the plurality of commands (the first command CMD_1 and the second command CMD_2) in the first command controller 100_1 and then sequentially output the plurality of commands to the first IP block 30_1 based on the plurality of pieces of data, thereby controlling successive operations of the first IP block 30_1. At the same time, when it is necessary for the CPU 20 to quickly control the operation of the first IP block 30_1, the first command controller 100_1 may directly transmit the third command CMD_3 to the first IP block 30_1 via the command distributor 110 and the command arbiter 130 of the first command controller 100_1 without storing the data corresponding to the third command CMD_3. Therefore, the integrated circuit 1 may be effectively used in various environments.

FIG. 5 shows that the first command controller 100_1 receives the first command CMD_1 and the second command CMD_2, stores the first data and the second data in operation S12, and then outputs the first command CMD_1 in operation S13, the disclosure is not limited thereto. As shown in FIG. 4, after the first command controller 100_1 outputs the first command CMD_1 to the first IP block 30_1 in operation S13, the CPU 20 may output the second command CMD_2 to the first command controller 100_1 in operation S11_1, and the first command controller 100_1 may receive the second command CMD_2.

FIG. 6 is a block diagram showing a command buffer included in an integrated circuit according to an example embodiment of the disclosure.

Referring to FIGS. 2 and 6, the command buffer 120 may include a FIFO circuit 121 and a FIFO controller 123.

The FIFO circuit 121 may be configured to store a plurality of pieces of data and operate in a first-in first-out manner. Therefore, the FIFO circuit 121 may operate to first-output first-input data input according to the first-in first-out manner. The FIFO circuit 121 may provide a write pointer (WP) indicating an address for writing input data and a read pointer (RP) indicating an address for reading output data.

The FIFO controller 123 may manage input/output of data of the FIFO circuit 121. When a data input occurs, the FIFO controller 123 may input and store data at an address indicated by the WP of the FIFO circuit 121 and increase the WP. When a data output occurs, the FIFO controller 123 may output data stored at an address indicated by the RP of the FIFO circuit 121 and increase the RP.

The FIFO controller 123 may include a controller register 123_1. The controller register 123_1 may store information regarding the FIFO circuit 121. For example, the controller register 123_1 may store information regarding data currently stored in the FIFO circuit 121 and information regarding data to be output from among the data stored in the FIFO 121.

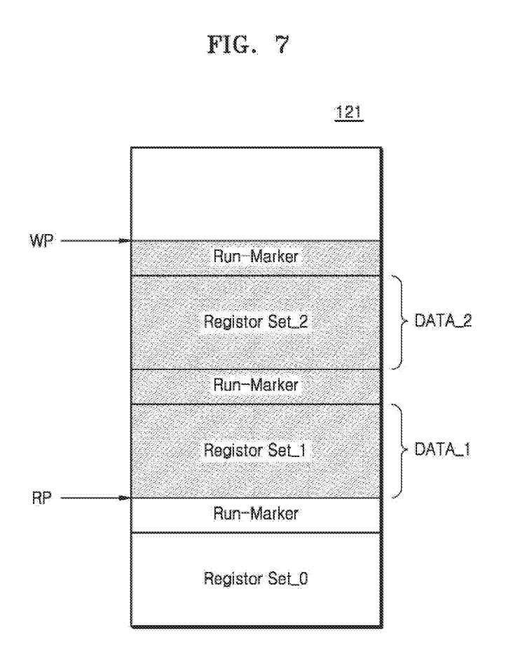

FIG. 7 is a block diagram showing a FIFO circuit included in the command buffer of FIG. 6 and is a diagram for describing the operations of the FIFO circuit.

Referring to FIGS. 2, 6, and 7, according to an example embodiment, the FIFO circuit 121 may be implemented with a plurality of registers. First data DATA_1 corresponding to the first command CMD_1 may be stored in a first register set Register Set_1 of the FIFO 121 and second data DATA_2 corresponding to the second command CMD_2 may be stored in a second register set Register Set_2. Each of the first register set Register Set_1 and the second register set Register Set_2 may include at least one register. A plurality of pieces of data stored in one register set may correspond to a command for instructing the first IP block 30_1 connected to the first command controller 100_1 to perform one operation.

Once all data is stored in one register set, a run-marker may be stored in a next register different from the one register set where all data is stored. In other words, after all data is stored in one register set, a run-marker is stored in a next register, and then other data may be stored in another register set. Therefore, one data group corresponding to a command for controlling one operation of an IP block is formed based on the run-marker. The FIFO controller 123 may manage the FIFO circuit 121 on a data group basis through a run-marker, and the FIFO circuit 121 may read data by data groups. Therefore, the FIFO circuit 121 may be easily managed.

The state of the FIFO circuit 121 may be determined by a WP and a RP. The WP may increase sequentially as data is stored in the FIFO 121. The RP may sequentially increase as data is output from the FIFO 121. Here, the WP may increase before the RP does. The reason thereof is that data may be output after the data is written to the FIFO circuit 121.

The FIFO circuit 121 may input data until the storage space is full and may output data until the storage space is empty. The FIFO controller 123 may determine that the storage space of the FIFO circuit 121 is full when a difference between the WP and the RP corresponds to the depth of the FIFO circuit 121. On the contrary, the FIFO controller 123 may determine that the storage space of the FIFO circuit 121 is empty when the WP and the RP indicate a same address.

As shown in FIG. 7, it may be observed that the first data DATA_1 and the second data DATA_2 are stored in the first register set Register Set_1 and the second register set Register Set_2 via the WP and a run-marker is stored thereafter. Furthermore, it may be observed that the first data DATA_1 and the second data DATA_2 are not yet output from the first register set Register Set_1 and the second register set Register Set_2 via the RP.

Although FIG. 7 shows that the FIFO circuit 121 includes a plurality of registers and the first data DATA_1 and the second data DATA_2 are respectively stored in the first register set Register Set_1 and the second register set Register Set_2, the disclosure is not limited thereto. According to another example embodiment, the FIFO circuit 121 may be implemented as a memory. For example, the FIFO circuit 121 may be configured as a high-speed static random access memory (SRAM) having an input port and a plurality of output ports. In this case, the first data DATA_1 corresponding to the first command CMD_1 may be stored in a first area of the memory, the second data DATA_2 corresponding to the second command CMD_2 may be stored in a second area of the memory different from the first area, and the first area and the second areas of the memory may be distinguished from each other by a third area where a run-marker is stored.

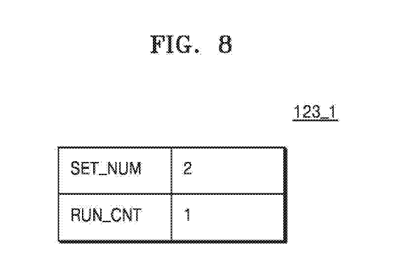

FIG. 8 is a diagram for describing a controller register included in the command buffer of FIG. 6.

Referring to FIG. 8, the controller register 123_1 may store information regarding data stored in a register set of the FIFO circuit 121 and information regarding data to be output from among data stored in the FIFO circuit 121. For example, the controller register 123_1 stores the number SET_NUM of register sets of the FIFO circuit 121 in which data is stored and the number RUN_CNT of register sets for outputting data from among the register sets of the FIFO circuit 121 having stored therein data.

Referring to FIGS. 6 through 8, the first data DATA_1 and the second data DATA_2 are stored in the first register set Register Set_1 and the second register set Register Set_2 in the FIFO circuit 121, and thus data is stored in two register sets in total. Therefore, the number SET_NUM of register sets in which data is stored may have a value of “2”.

The FIFO controller 123 may determine the number of register sets SET_NUM of the FIFO circuit 121 in which data corresponding to one command is stored based on the WP, the RP, and the number of run-markers stored in the FIFO circuit 121. Furthermore, the FIFO controller 123 may also select a register to output data from among a plurality of registers of the FIFO circuit 121 based on the number RUN_CNT of register sets for outputting data and a corresponding run-marker.

The number RUN_CNT of register sets for outputting data from among the register sets in which data is stored may have a value smaller than the number SET_NUM of register sets in which data is stored. For example, the number RUN_CNT of register sets for outputting data from between two register sets in which data is stored may have a value of 1. A CPU may control the FIFO controller 123, such that the number RUN_CNT of register sets for outputting data is stored in the controller register 123_1.

For a command arbiter to control operations of an IP block, the command buffer 120 may output the first command CMD_1 corresponding to the first data DATA_1 that is stored before the second data DATA_2 based on the information stored in the controller register 123_1. Since the number RUN_CNT of register sets for outputting data has the value of 1, the command buffer 120 may wait without outputting the second command CMD_2 corresponding to the second data DATA_2. However, the number RUN_CNT of register sets for outputting data may vary depending on characteristics of an IP block whose operation is controlled.

For example, as shown in FIG. 8, when the number RUN_CNT of register sets for outputting data is 2, the command buffer 120 may output the second command CMD_2 to the command arbiter successively after the first command CMD_1. In other words, after the command buffer 120 outputs the first command CMD_1 corresponding to the first data DATA_1 by preferentially performing a reading operation with respect to the first data DATA_1 based on a run-marker stored in the FIFO circuit 121, the command buffer may successively perform a reading operation with respect to the second data DATA_2 or may wait without performing a reading operation with respect to the second data DATA_2 until a separate command is received from a CPU.

According to an example embodiment, depending on the number of registers to be set, the FIFO circuit 121 may be implemented as a memory, rather than a flip-flop.

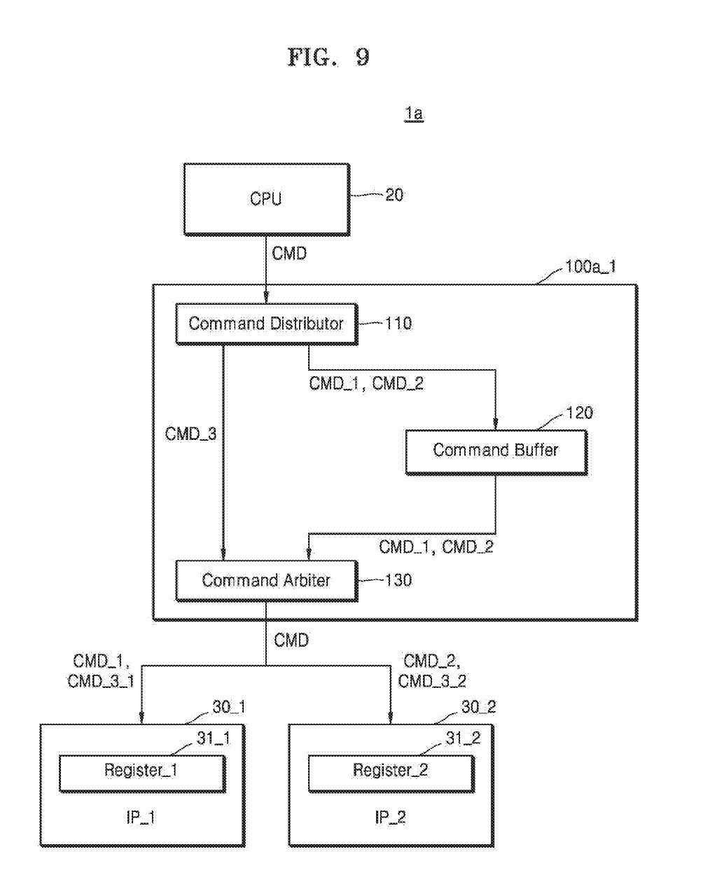

FIG. 9 is a block diagram showing an integrated circuit according to an example embodiment of the disclosure. Compared with FIG. 2, FIG. 9 is a diagram for describing that a first command controller 100_1a may be connected to a plurality of IP blocks and may transmit commands respectively to the plurality of IP blocks. In FIG. 9, descriptions identical to those given above with reference to FIG. 2 will be omitted. Although only the first command controller 100a_1 is shown in FIG. 9, the description given below with reference to FIG. 9 may be applied to each of the plurality of command controllers 100 of FIG. 1.

Referring to FIG. 9, an integrated circuit 1a may include the CPU 20, the first command controller 100a_1, the first IP block 30_1, and a second IP block 30_2. The first command controller 100a_1 may include the command distributor 110, the command buffer 120, and the command arbiter 130. The command distributor 110, the command buffer 120, and the command arbiter 130 may perform the same functions as the command distributor 110, the command buffer 120 and the command arbiter 130 in FIG. 2. The CPU 20 may output a plurality of commands CMD to the first command controller 100a_1.

The first command controller 100a_1 may receive the plurality of commands CMD including a first command CMD_1 and a second command CMD_2 from the CPU 20. The first command CMD_1 may be a command for controlling the operation of the first IP block 30_1, whereas the second command CMD_2 may be a command for controlling the operation of the second IP block 30_2.

The first command controller 100a_1 may sequentially output the first command CMD_1 and the second command CMD_2 in the order received. When the first command controller 100a_1 outputs the first command CMD_1 and the second command CMD_2, the first command CMD_1 may be transmitted to the first IP block 30_1 and the second command CMD_2 may be transmitted to the second IP block 30_2, by a decoder included in a system bus.

Although FIG. 9 shows that the first command controller 100a_1 outputs the first command CMD_1 and the second command CMD_2 for controlling the operation of two IP blocks, that is, the first IP block 30_1 and the second IP block 30_2, the disclosure is not limited thereto. The first command controller 100a_1 may further output a command for controlling the operation of other IP blocks. In other words, one command controller may control the operations of a plurality of IP blocks.

The first command controller 100a_1 may also receive a third command CMD_3. At this time, the third command CMD_3 may be a command CMD_3_1 for controlling the operation of the first IP block 30_1 or a command CMD_3_2 for controlling the operation of the second IP block 30_2. The first command controller 100a_1 may not separately store data corresponding to the third command CMD_3 in the command buffer 120. In other words, the command distributor 110 of the first command controller 100a_1 may directly transmit the third command CMD_3 to the command arbiter 130.

When the command arbiter 130 receives the third command CMD_3 from the command distributor 110 and simultaneously receives the first command CMD_1 or the second command CMD_2 from the command buffer 120, the command arbiter 130 may preferentially output a command having higher priority from the received commands.

A first IP block IP_1 may include a first IP register 31_1, and a second IP block IP_2 may include a second IP register 31_2. Based on the received first command CMD_1 or third command CMD_3_1, the first IP register 31_1 may be set to a certain value. Furthermore, based on the received second command CMD_2 or third command CMD_3_2, the second IP register 31_2 may be set to a certain value. The first IP block IP_1 may perform an operation based on the value of the first IP register 31_1 and the second IP block IP_2 may perform an operation based on the value of the second IP register 31_2.

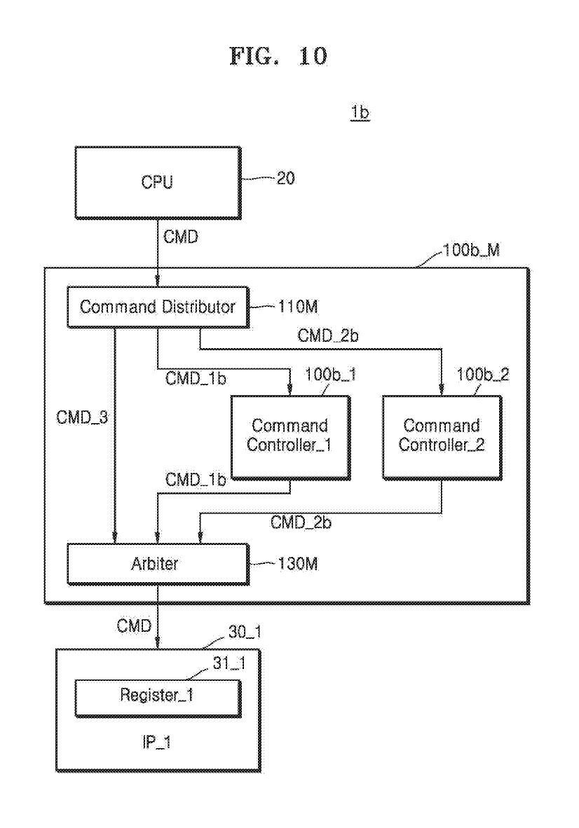

FIG. 10 is a block diagram showing an integrated circuit according to an example embodiment of the disclosure. Compared with FIG. 2, FIG. 10 is a diagram for describing that a plurality of command controllers 100b_1 and 100b_2 may control the operation of a same functional block. Although FIG. 10 shows only the case of controlling the operation of the first IP block 30_1, the disclosure is not limited thereto, and the plurality of command controllers 100b_1 and 100b_2 may control the operation of a plurality of IP blocks. In FIG. 10, descriptions given above with reference to FIG. 2 will be omitted.

Referring to FIG. 10, an integrated circuit 1b may include the CPU 20, the first command controller 100b_1, the second command controller 100b_2, and the first IP block 30_1. Here, the first command controller 100b_1 and the second command controller 100b_2 may constitute one multi-command controller 100b_M. The multi-command controller 100b_M may further include a distributor 110M and an arbiter 130M in addition to the first command controller 100b_1 and the second command controller 100b_2.

The CPU 20 may output a plurality of commands CMD to the multi-command controller 100b_M. At this time, the CPU 20 may output a plurality of first commands CMD_1b to control a first successive operation of the first IP block 30_1, may output a plurality of second commands CMD_2b to control a second successive operation of the first IP block 30_1 different from the first successive operation, and, when an urgent processing is necessary with respect to the first IP block 30_1, may output a third command CMD_3 to the multi-command controller 100b_M.

The distributor 110M may receive a plurality of commands CMD from the CPU 20. The distributor 110M may distribute the plurality of commands CMD to a plurality of first commands CMD_1b to be transmitted to the first command controller 100b_1, a plurality of second commands CMD_2b to be transmitted to the second command controller 100b_2, and a third command CMD_3 to be transmitted to the arbiter 130M.

According to an example embodiment, the distributor 110M may be a decoder and, based on addresses received together with the plurality of commands CMD, may transmit the plurality of first commands CMD_1b and the plurality of second commands CMD_2b to the first command controller 100b_1 and the second command controller 100b_2 and transmit the third command CMD_3 to the arbiter 130M.

Each of the first command controller 100b_1 and the second command controller 100b_2 included in the multi-command controller 100b_M may perform operations identical to those of the first command controller 100_1 of FIG. 2. However, the first command controller 100b_1 may be configured to control a first successive operation of the first IP block 30_1 and the second command controller 100b_2 may be configured to control a second successive operation of the first IP block 30_1, thereby controlling different successive operations.

Each of the first command controller 100b_1 and the second command controller 100b_2 may include a FIFO structure. First data corresponding to the plurality of first commands CMD_1b may be stored in the FIFO buffer of the first command controller 100b_1, and second data corresponding to the plurality of second commands CMD_2b may be stored in the FIFO buffer of the second command controller 100b_2. According to an example embodiment, the FIFO buffers of the first command controller 100b_1 and the second command controller 100b_2 may be implemented similarly to the FIFO circuit 121 of FIG. 7, but are not limited thereto, and the FIFO buffers of the first command controller 100b_1 and the second command controller 100b_2 may be implemented as memories.

The first command controller 100b_1 may sequentially output the plurality of first commands CMD_1b in an order that the plurality of first commands CMD_1b are input based on the first data stored in the FIFO. The second command controller 100b_2 may also sequentially output the plurality of second commands CMD_2b in the order that the plurality of second commands CMD_2b are input based on the second data stored in the FIFO. At this time, the first command controller 100b_1 and the second command controller 100b_2 may read only parts of the first data and the second data from the FIFO or may sequentially output only some of the plurality of first commands CMD_1b and the plurality of second commands CMD_2b. The other parts of the first data and the second data that are not read out may not be read out from the FIFOs until a signal comes from the CPU 20 or the first IP block 30_1.

The arbiter 130M may transmit the plurality of first commands CMD_1b, the plurality of second commands CMD_2b, or the third command CMD_3 to the first IP block 30_1. When the plurality of first commands CMD_1b, the plurality of second commands CMD_2b, and the third command CMD_3 are received by the arbiter 130M in different time slots, the plurality of first commands CMD_1b, the plurality of second commands CMD_2b, or the third command CMD_3 may be independently transmitted to the first IP block 30_1.

On the other hand, when the time slots in which the third command CMD_3 and the plurality of first commands CMD_1b or the plurality of second commands CMD_2b are received by the arbiter 130M overlap each other, the arbiter 130M may preferentially output a command having higher priority from among received commands to the first IP block 30_1. Therefore, according to an example embodiment, the arbiter 130M may include a register in which priorities regarding received commands are stored.

The first IP register 31_1 of the first IP block IP_1 may be sequentially set based on a plurality of first commands CMD_1b when the plurality of first commands CMD_1b are sequentially received. Respective operations may be performed based on the set values of the first IP register 31_1, thereby performing one first successive operation. Alternatively, the first IP register 31_1 of the first IP block IP_1 may be sequentially set based on a plurality of second commands CMD_2b when the plurality of second commands CMD_2b are sequentially received. Respective operations may be performed based on the set values of the first IP register 31_1, thereby performing one second successive operation. Alternatively, the first IP block IP_1 may set the first IP register 31_1 based on the received third command CMD_3 and perform a third operation.

The integrated circuit 1b according to an example embodiment of the disclosure may independently control a plurality of different successive operations of the first IP block 30_1 without an intervention of the CPU 20. As a result, the burden on the CPU 20 may be reduced, and a time period for controlling the first IP block 30_1 to perform a plurality of continuous operations may be reduced.

Although FIG. 10 shows that the multi-command controller 100b_M includes the first command controller 100b_1 and the second command controller 100b_2 to control two continuous operations of one IP block, that is, the first IP block 30_1, the disclosure is not limited thereto, and the multi-command controller 100b_M may include a plurality of command controllers and may be connected to a plurality of IP blocks, to control a plurality of successive operations of the plurality of IP blocks. IP blocks controlled by the plurality of command controllers included in the multi-command controller 100b_M may vary in some cases, wherein the plurality of command controllers may control a same IP block, may control different IP blocks, or may each control a plurality of IP blocks.

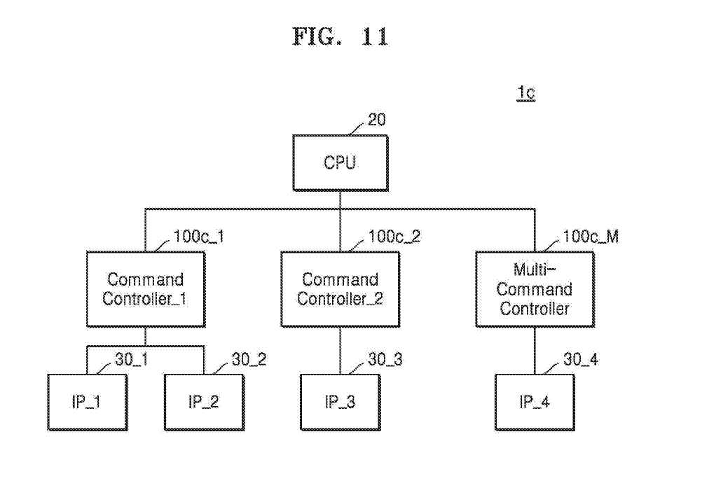

FIG. 11 is a block diagram showing an integrated circuit according to an example embodiment of the disclosure. FIG. 11 is a diagram for describing that the integrated circuit may include a plurality of command controllers having various configurations.

Referring to FIG. 11, an integrated circuit 1c may include the CPU 20, a first command controller 100c_1, a second command controller 100c_2, and a multi-command controller 100c_M.

The first command controller 100c_1 may output a plurality of commands for instructing the first IP block 30_1 and the second IP block 30_2 to perform certain operations, respectively. The first command controller 100c_1 may operate similarly to the first command controller 100a_1 of FIG. 9.

The second command controller 100c_2 may output a plurality of commands for instructing a third functional block 30_3 to perform certain operations. The second command controller 100c_2 may operate similarly to the first command controller 100_1 of FIG. 2.

The multi-command controller 100c_M may output a plurality of commands for instructing a fourth functional block 30_4 to perform certain operations. The multi-command controller 100c_M may include a plurality of command controllers. The multi-command controller 100c_M may operate similarly to the multi-command controller 100b_M of FIG. 10.

Therefore, the integrated circuit 1c according to an example embodiment of the disclosure may include a plurality of command controllers and a plurality of multi-command controllers that may be variously implemented and, by taking characteristics of a plurality of IP blocks included in the integrated circuit 1c, may be configured to be connected to the first command controller 100c_1, the second command controller 100c_2, or the multi-command controller 100c_M. In some cases, some of the plurality of IP blocks included in the integrated circuit 1c may be configured to not be connected to the first command controller 100c_1, the second command controller 100c_2 or the multi-command controller 100c_M and to receive commands directly from the CPU 20.

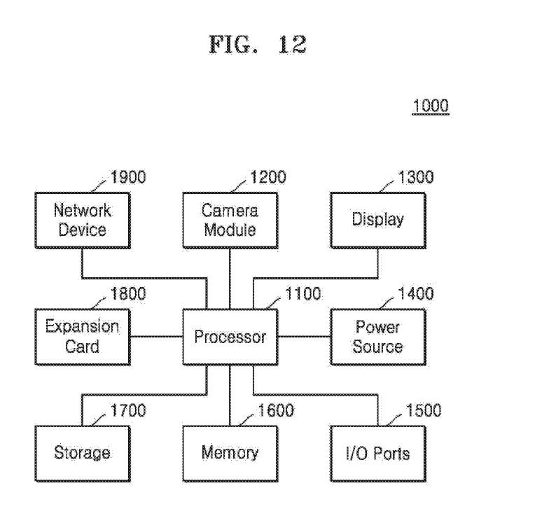

FIG. 12 is a diagram showing an example of an electronic system including an integrated circuit according to an example embodiment of the disclosure.

Referring to FIG. 12, an electronic system 1000 is a portable electronic device and may be implemented as a mobile phone, a smart phone, a tablet PC, a laptop PC, a PDA, an enterprise digital assistant (EDA), a digital camera, a PMP, a personal navigation device (PND), a handheld game console, an e-book, etc. The electronic system 1000 may include a processor 1100, a camera module 1200, a display 1300, a power source 1400, input/output ports 1500, a memory 1600, a storage 1700, an extension card 1800, and a network device 1900.

The processor 1100 may be a multi-core processor, may control the camera module 1200, display 1300, power source 1400, input/output ports 1500, memory 1600, storage 1700, extension card 1800, and network device 1900 of the electronic system 1000, and may be an AP (AP), for example. The processor 1100 may include the integrated circuit 1, 1a, 1b, and 1c according to example embodiments of the disclosure shown in FIGS. 1, 2, and 9 through 11. As the processor 1100 includes a plurality of command controllers, a CPU included in the processor 1100 may output a plurality of commands for operating the components like the camera module 1200 and the display 1300 without being affected by time.

The camera module 1200 may include a lens and an image sensor and may provide image data corresponding to an optical image to the processor 1100. The display 1300 may display an image or a video based on data received from the processor 1100.

The power source 1400 may include a battery and a battery controller and may supply power to the components of the electronic system 1000. The input/output ports 1500 are used to transmit data from the outside to the electronic system 1000 or to transmit data from the electronic system 1000 to the outside and may include universal serial bus (USB) ports, for example. The memory 1600 may store data necessary for operations of the electronic system 1000, e.g., data generated by the processor 1100.

The storage 1700 may have a relatively large data storage capacity and may store data, such as programs and multimedia data, in non-volatile manner Therefore, even when power supplied to the integrated circuit 1, 1a, 1b, and 1c according to example embodiments of the disclosure is interrupted, data stored therein may not be lost. For example, the storage 1700 may include a non-volatile memory, such as an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), and a ferroelectric random access memory (FRAM), and a storage medium, such as a magnetic tape, an optical disc, and a magnetic disk.

The extension card 1800 may be implemented as a secure digital (SD) card, a multimedia card (MMC), a subscriber identification module (SIM) card, a universal subscriber identification module (USIM) card, etc. The network device 1900 may provide the electronic system 1000 an access to a wire network or a wireless network.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

While the disclosure has been particularly shown and described with reference to embodiments thereof, it will be understood that various changes in form and details may be made therein without departing from the spirit and scope of the following claims.

What is claimed is:

1. An application processor comprising:
a plurality of intellectual property blocks including a first intellectual property block and a second intellectual property block; and
a system bus comprising a first command controller and a second command controller, wherein:
each of the first command controller and the second command controller comprises:
a command distributor configured to receive first through third commands from a central processing unit (CPU);
a command buffer configured to sequentially receive the first command and the second command from the command distributor and to output the first command and the second command at different time slots; and
a command arbiter configured to receive the first and second commands from the command buffer and a third command from the command distributor and to selectively output the first, second, and third commands, and
first data corresponding the first command, second data corresponding to the second command, and a run-marker are stored in the command buffer.

2. The application processor of claim 1, wherein:
the command buffer comprises a first-in first-out (FIFO) circuit, and
the first data, the run-marker, and the second data are sequentially stored in the FIFO circuit.

3. The application processor of claim 2, wherein the command buffer is configured to preferentially perform a reading operation with respect to the first data, to output the first command corresponding to the first data, and to perform a reading operation with respect to the second data, based on the run-marker stored in the FIFO circuit.

4. The application processor of claim 1, wherein the command arbiter is configured to select and output one of the second command and the third command according to priorities when the second command and the third command are received together.

5. The application processor of claim 1, wherein the command arbiter comprises a register configured to store priorities of the first through third commands.

6. The application processor of claim 1, wherein:
the first command output from the first command controller is transmitted to the first intellectual property block from among the plurality of intellectual property blocks, and
the second command output from the second command controller is transmitted to the second intellectual property block from among the plurality of intellectual property blocks.

7. The application processor of claim 1, wherein the first command controller and the second command controller are each configured to output the first through third commands to the first intellectual property block from among the plurality of intellectual property blocks.

8. The application processor of claim 1, wherein the command buffer is configured to output the first command after the first data and the second data are stored.

9. The application processor of claim 1, wherein the command buffer is configured to receive the second command from the command distributor after the first command is output.

10. The application processor of claim 1, wherein the command distributor comprises a decoder and is configured to transmit the first and second commands to the command buffer and to transmit the third command to the command arbiter based on addresses received from the CPU.

11. The application processor of claim 1, wherein:
each of the first intellectual property block and the second intellectual property block from among the plurality of intellectual property blocks comprises a plurality of special function registers,
the first intellectual property block is configured to receive the first through third commands from the first command controller, and
the plurality of special function registers included in the first intellectual property block are respectively configured to be set based on the first through third commands.

12. An application processor comprising:
a plurality of intellectual property blocks; and
a system bus comprising a plurality of command controllers that each includes a first-in first-out (FIFO) circuit, wherein:
each of the plurality of command controllers is configured to sequentially receive a first command and a second command from a central processing unit (CPU) and to sequentially output the first command and the second command, and
first data corresponding the first command, second data corresponding to the second command, and a run-marker are stored in the FIFO circuit.

13. The application processor of claim 12, wherein:
the FIFO circuit comprises a plurality of registers,
the plurality of registers comprise a first register set in which the first data is stored, a second register set in which the second data is stored, and a third register in which the run-marker is stored, and
when the first data is stored in the first register set, the run-marker is stored in the third register.

14. The application processor of claim 13, wherein the plurality of command controllers is configured to preferentially perform a reading operation with respect to the first register set, to output the first command corresponding to the first data, and to perform a reading operation with respect to the second register set, based on the third register set.

15. The application processor of claim 12, wherein at least one of the plurality of command controllers is configured to output the first command corresponding to the first data after the first data and the second data are stored in the FIFO circuit.

16. The application processor of claim 12, wherein at least one of the plurality of intellectual property blocks is configured to sequentially receive the first command and the second command output from one of the plurality of command controllers and to sequentially perform different operations.

17. The application processor of claim 12, wherein:
each of the plurality of command controllers is configured to receive a third command from the CPU after the first command and the second command, and
each of the command controllers is configured to output the third command before the first command and the second command.

18. The application processor of claim 12, wherein:
the plurality of command controllers comprises a first command controller and a second command controller that are each configured to output a plurality of different commands, and
the first command controller and the second command controller are each configured to respectively output the first command and the second command to a same intellectual property block from among the plurality of intellectual property blocks.

19. An integrated circuit comprising:
a plurality of intellectual property blocks; and
a system bus configured to output commands to the plurality of intellectual property blocks and comprising a command controller, wherein:
the command controller comprises:
a command distributor configured to receive a plurality of commands from a central processing unit (CPU);
a first-in first-out (FIFO) circuit configured to sequentially receive some of the plurality of commands from the command distributor, to store data corresponding to the some of the plurality of commands, and to sequentially output the some of the plurality of commands; and
a command arbiter configured to receive and selectively output the some of the plurality of commands received from the FIFO circuit and another of the plurality of commands directly received from the command distributor.

20. The integrated circuit of claim 19, wherein the command arbiter is configured to selectively output commands according to priorities thereof when the commands are received together from the FIFO circuit and the command distributor.
